(19) United States
(12) Patent Application Publication
(10) Pub. No.: US 2026/0004420 A1
(43) Pub. Date: Jan. 1, 2026

(54) IMAGE INSPECTION APPARATUS, IMAGE FORMING APPARATUS, IMAGE INSPECTION METHOD, AND STORAGE MEDIUM

(71) Applicant: CANON KABUSHIKI KAISHA, Tokyo (JP)

(72) Inventor: RYO KAZUMI, Kanagawa (JP)

(21) Appl. No.: 19/246,076

(22) Filed: Jun. 23, 2025

(30) Foreign Application Priority Data
Jun. 26, 2024 (JP) 2024-103286

(51) Int. Cl. G06T 7/00; G03G 15/00; G03G 15/22; G06K 15/00; G06K 15/02

(52) U.S. Cl. CPC G06T 7/001; G03G 15/228; G03G 15/5016; G06K 15/005; G06K 15/027; G06T 2207/30144

(57) ABSTRACT

An image inspection apparatus includes a scanning unit that scans a sheet conveyed from an image forming unit. The apparatus compares a scanned overall image of the sheet with a reference image to detect misalignment in image formation. Based on the misalignment, it aligns the scanned image with the reference image to generate a first image. The first image is then compared with the reference image to detect local distortions in different parts of the image. Based on the detected distortions, the apparatus performs local alignment to generate a second image. It then calculates distortion amounts for each part and determines whether the image is normal based on these values. This enables determination of image normality based on both misalignment and distortion.

### BACKGROUND

### Field of the Technology

The present disclosure relates to an inspection apparatus, an image forming apparatus, an inspection method and a storage medium.

### Description of the Related Art

In recent years, there has been known a print system in which a print sheet printed by a print apparatus can be inspected by an image inspection apparatus during conveyance. In the inspection, the image inspection apparatus scans the image on the conveyed print sheet, and analyzes the scanned image, thereby determining whether or not the print sheet is normal. The image inspection apparatus can detect, for example, misalignment (overall positional misalignment) between a print position of a picture and a print paper, a print abnormality, and the like. When the print sheet is determined to be an abnormality in this manner, the abnormal sheet is discharged to a discharge destination different from a normal sheet. This prevents the abnormal sheet from being mixed into the normal sheet, and enables the operator to discard the abnormal sheet.

The print apparatus may have a misalignment by several mm in the print position depending on the conveyance speed, the device, the print paper storage environment, and the print image. Japanese Patent Laid-Open No. 2010-165011 proposes an image inspection apparatus for a print image that scans a print sheet by a scanner of the image inspection apparatus, performs edge detection, and compares the detected edge with an edge of a reference image to detect misalignment.

Of the misalignment, a misalignment due to a print image occurs when a sheet becomes slippery due to the toner being placed on print paper, and a printed picture shrinks due to reduction of paper conveying force. When misalignment or distortion affects the size of the overall picture, adjustment at a cut position is possible by adjusting the overall positional misalignment so as to align the four corner positions of the picture, such as register alignment adjustment. However, misalignment due to the print image has the way of misalignment that varies depending on the toner density, the way of misalignment is different at each part of the picture, which causes occurrence of partial positional misalignment. Therefore, the proposed image inspection apparatus cannot cope with a case where misalignment is different at each part of a print sheet.

### SUMMARY

The present disclosure enables realization of a technique for detecting distortion of each part of a print sheet.

One aspect of the present disclosure provides an image inspection apparatus comprising: a scanning unit configured to scan a sheet on which an image is formed, the sheet being conveyed from an image forming unit; one or more memory devices that store a set of instructions; and one or more processors that execute the set of instructions to: compare an overall image of the sheet scanned by the scanning unit with an overall reference image to detect a misalignment in a formation position in the image of the sheet, and align the image of the sheet with the reference image based on the misalignment to acquire a first image; compare the first image with the reference image, detect distortion for each part of the image of the sheet, and locally align the first image with the reference image based on the distortion to acquire a second image; and acquire a distortion amount from the distortion for each part to determine whether the image of the sheet is normal.

Another aspect of the present disclosure provides an image inspection method comprising: scanning a sheet on which an image is formed, the sheet being conveyed from an image forming unit; comparing an overall image of the sheet scanned by the scanning unit with an overall reference image to detect a misalignment in a formation position in the image of the sheet, and aligning the image of the sheet with the reference image based on the misalignment to acquire a first image; comparing the first image with the reference image, detecting distortion for each part of the image of the sheet, and locally aligning the first image with the reference image based on the distortion to acquire a second image; and acquiring a distortion amount from the distortion for each part to determine whether the image of the sheet is normal.

Still another aspect of the present disclosure provides a non-transitory computer-readable storage medium storing a program which, when executed by a computer of an inspection apparatus, causes the computer to perform an image inspection method, the inspection apparatus comprising a scanning unit configured to scan a sheet on which an image is formed, the sheet being conveyed from an image forming unit, the method comprising: comparing an overall image of the sheet scanned by the scanning unit with an overall reference image to detect a misalignment in a formation position in the image of the sheet, and aligning the image of the sheet with the reference image based on the misalignment to acquire a first image, comparing the first image with the reference image, detecting distortion for each part of the image of the sheet, and locally aligning the first image with the reference image based on the distortion to acquire a second image, and acquiring a distortion amount from the distortion for each part to determine whether the image of the sheet is normal.

Yet still another aspect of the present disclosure provides an image forming apparatus comprising: an image forming unit configured to form an image on a sheet; and the above inspection apparatus.

### BRIEF DESCRIPTION OF THE DRAWINGS

FIG. 1 is an overall view of a print system.

FIG. 2 is a block diagram illustrating a system configuration of the print system.

FIG. 3 is a cross-sectional view of an image forming apparatus.

FIG. 4 is a flowchart of overall inspection processing.

FIG. 5 is a flowchart of inspection execution.

FIG. 6 is a flow of alignment.

FIG. 7 is a flow of overall alignment.

FIG. 8 is a flow of partial alignment.

FIG. 9 is a flowchart of acquiring a positional misalignment amount.

FIG. 10 is a flowchart of acquiring an overall positional misalignment amount.

FIG. 11 is a flow of acquiring a distortion amount.

FIG. 12 is an example of an inspection setting UI.

FIG. 13 is an example of display of an inspection result.

FIG. 14 is a view describing occurrence of local distortion.

FIG. 15 is a view describing free form deformations.

FIGS. 16A and 16B are views describing calibration.

FIG. 17 is a flow of removing scan distortion using a calibration chart.

FIG. 18 is a flowchart of acquiring print distortion from which scan distortion is removed using a calibration chart.

FIG. 19 is an example of presenting a recurrence prevention measure and a recurrence reduction measure for an abnormal sheet.

FIG. 20 is an example of presenting a recurrence prevention measure and a recurrence reduction measure for an abnormal sheet.

FIG. 21 is a flowchart of setting a preset basic value from sheet information.

FIG. 22 is a basic value table of a threshold of a distortion amount corresponding to the sheet information.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the following description, an external controller may also be called an image processing controller, a digital front end, a print server, a DFE, or the like. An image forming apparatus may be called a multifunction machine, a multifunction peripheral, or an MFP.

### First Embodiment

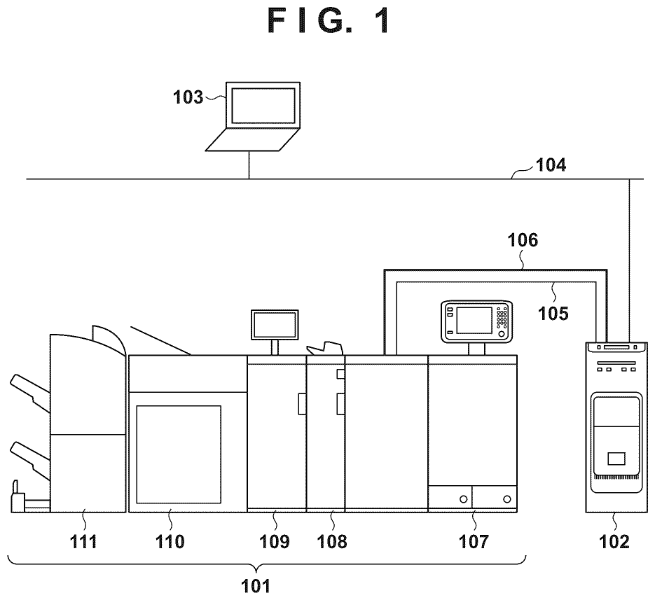

A hardware configuration of a print system according to the present embodiment will be described with reference to FIG. 1. The print system includes an image forming apparatus 101 and an external controller 102. The image forming apparatus 101 and the external controller 102 are connected to each other in a communication-enabling manner via an internal LAN 105 and a video cable 106. The external controller 102 is connected to a client PC 103 in a communication-enabling manner via an external LAN 104, and a print instruction is given from the client PC 103 to the external controller 102. Note that the image forming apparatus 101 and the external controller 102 may be connected by only any one of the internal LAN 105 and the video cable 106 as long as the external controller 102 can control the operation of the image forming apparatus 101.

A printer driver having a function of converting print data into a print description language processable by the external controller 102 is installed in the client PC 103. A user who performs printing can give a print instruction from various applications via the printer driver. The printer driver transmits print data to the external controller 102 based on a print instruction from the user. Upon receiving a print instruction from the client PC 103, the external controller 102 performs data analysis and rasterizing processing, inputs print data to the image forming apparatus 101, and gives a print instruction.

Next, the image forming apparatus 101 will be described. The image forming apparatus 101 is configured by connecting a plurality of apparatuses having different functions. For example, the image forming apparatus 101 is configured to include a print apparatus 107, an inserter 108, an image inspection apparatus 109, a large-capacity stacker 110, and a finisher 111.

The print apparatus 107 forms an image using toner on a medium before print (print paper, hereinafter called sheet) conveyed from a sheet feed unit present in a lower portion of the print apparatus 107. Here, the sheet is a storage medium on which an image is formed, and includes various media such as plain paper, thick paper, and an OHP sheet. The print paper on which the image is printed in this manner is hereinafter called a print sheet.

The inserter 108 inserts an insertion sheet into a printed matter printed by the print apparatus 107. The insertion sheet can be inserted into an arbitrary position of a print sheet group printed and conveyed by the print apparatus 107.

The image inspection apparatus 109 scans the image on the conveyed print sheet and compares the image with a reference image serving as a correct answer registered in advance, thereby determining whether the printed image is normal.

The large-capacity stacker 110 can stack large-capacity sheets. The finisher 111 performs finishing processing for a conveyed sheet. The finisher 111 can perform finishing such as stapling, punching, and saddle stitching, and discharges, to a discharge tray, a sheet that has undergone the finishing processing.

Although the print system described in FIG. 1 has a configuration in which the external controller 102 is connected to the image forming apparatus 101, the present disclosure is not limited to the configuration in which the external controller 102 is connected. That is, a configuration in which the image forming apparatus 101 is connected to the external LAN 104, and print data processable by the image forming apparatus 101 is transmitted from the client PC 103, or a configuration in which print data is read from a HDD 221 described later inside the print apparatus 107 may be adopted. In this case, the image forming apparatus 101 executes data analysis and rasterizing processing, and performs print processing.

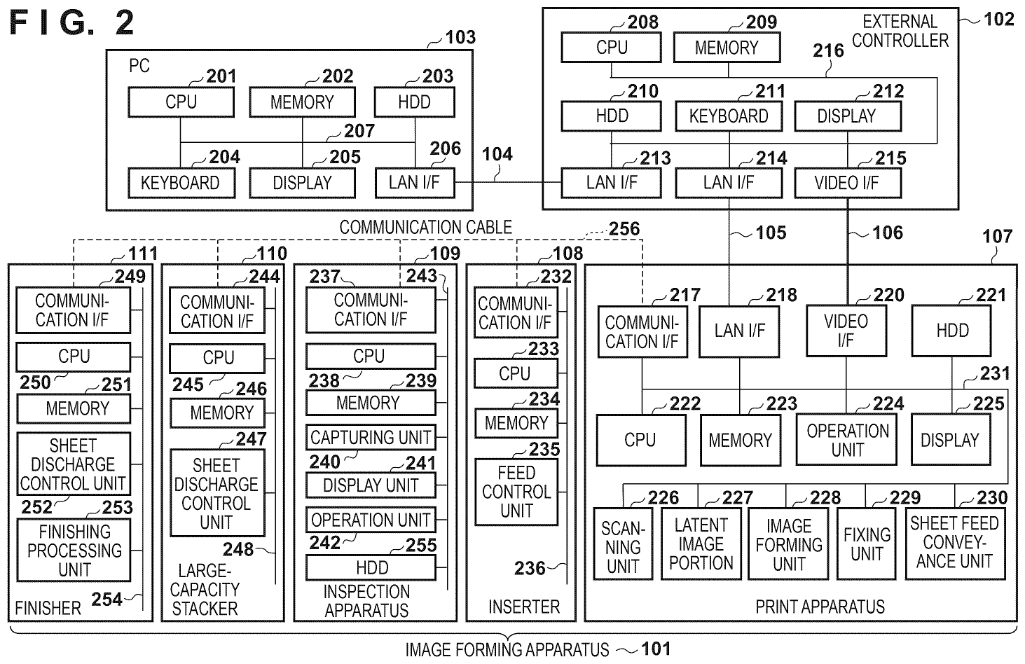

Internal configurations of the image forming apparatus 101, the external controller 102, and the client PC 103 will be described with reference to FIG. 2.

First, a configuration of the print apparatus 107 of the image forming apparatus 101 will be described. The print apparatus 107 of the image forming apparatus 101 is configured to include a communication interface (I/F) 217, a LAN I/F 218, a video I/F 220, an HDD 221, a CPU 222, a memory 223, an operation unit 224, and a display 225. Furthermore, the print apparatus 107 of the image forming apparatus 101 includes a document scanning unit 226, a latent image portion 227, an image forming unit 228, a fixing unit 229, and a sheet feed conveyance unit 230. Those components are connected via a system bus 231.

The communication I/F 217 is connected to the inserter 108, the image inspection apparatus 109, the large-capacity stacker 110, and the finisher 111 via a communication cable 256, and performs communication for controlling the respective apparatuses.

The LAN I/F 218 is connected to the external controller 102 via the internal LAN 105, and performs communication such as print data.

The video I/F 220 is connected to the external controller 102 via the video cable 106, and performs communication such as image data.

The HDD 221 is a storage apparatus storing programs and data. The CPU 222 comprehensively performs image processing control and control of print based on a program or the like stored in the HDD 221. The memory 223 stores programs necessary for the CPU 222 to perform various types of processing and image data, and operates as a work area. The operation unit 224 receives input of various settings and an instruction for operation from the user. The display 225 displays setting information of the image forming apparatus, a processing status of a print job, and the like. The document scanning unit 226 performs a processing of scanning a document when a copy function or a scan function is used. The document scanning unit 226 scans document data by capturing an image with a CMOS image sensor while illuminating a sheet placed by the user with an exposure lamp.

The latent image portion 227 performs primary charge for irradiating a photosensitive drum with laser light and laser exposure in order to develop a toner image. In the latent image portion 227, first, primary charge of charging the surface of the photosensitive drum to a uniform negative potential is performed. Next, the photosensitive drum is irradiated with laser light by a laser driver while a reflection angle is adjusted by a polygon mirror, and an electrostatic latent image is formed. The image forming unit 228 is an apparatus for transferring toner to a sheet, and includes a developing unit, a transfer unit, and a toner supply unit, and transfers the toner on the photosensitive drum to the sheet.

In the developing unit, the toner negatively charged from a developing cylinder is caused to adhere to the electrostatic latent image on the surface of the photosensitive drum and visualized. The transfer unit performs primary transfer in which a primary transfer roller is applied with a positive potential and the toner on the surface of the photosensitive drum is transferred to a transfer belt, and secondary transfer in which an external secondary transfer roller is applied with a positive potential and the toner on the transfer belt is transferred to the sheet. The fixing unit 229 is an apparatus for dissolving and fixing the toner on the sheet to the sheet by heat and pressure, and includes a heater, a fixing belt, and a pressure belt. The sheet feed conveyance unit 230 is an apparatus for feeding a sheet, and controls a sheet feed operation and a conveyance operation of the sheet by a roller and various sensors.

Next, a configuration of the inserter 108 of the image forming apparatus 101 will be described. The inserter 108 of the image forming apparatus 101 is configured to include a communication I/F 232, a CPU 233, a memory 234, and a sheet feed control unit 235. Those components are connected via a system bus 236. The communication I/F 232 is connected to the print apparatus 107 via the communication cable 256, and performs communication necessary for control. The CPU 233 performs various types of control necessary for sheet feed in accordance with a control program stored in the memory 234. The memory 234 is a storage apparatus storing a control program. The sheet feed control unit 235 controls a roller and a sensor based on an instruction from the CPU 233, and controls sheet feed and conveyance of a sheet conveyed from the sheet feed unit of the inserter and the print apparatus 107.

Next, a configuration of the image inspection apparatus 109 of the image forming apparatus 101 will be described. The image inspection apparatus 109 of the image forming apparatus 101 is configured to include a communication I/F 237, a CPU 238, a memory 239, a capturing unit 240, a display unit 241, an operation unit 242, and an HDD 255. Those components are connected via a system bus 243. The communication I/F 237 is connected to the print apparatus 107 via the communication cable 256, and performs communication necessary for control. The CPU 238 performs various types of control necessary for inspection in accordance with a control program stored in the memory 239. The memory 239 is a storage apparatus storing a control program.

The capturing unit 240 captures a conveyed sheet based on an instruction from the CPU 238. The CPU 238 stores the image captured by the capturing unit 240 in the memory 239 as a reference image serving as a correct answer. Furthermore, the CPU 238 compares the image captured by the capturing unit 240 with the reference image stored in the memory 239, and determines whether the printed image is normal. The display unit 241 displays an inspection result, a setting screen, and the like. The operation unit 242 is operated by the user, and receives an instruction for setting change of the image inspection apparatus 109, registration of the reference image, and the like. The HDD 255 stores various types of setting information and images necessary for inspection. The saved various types of setting information and images can be reused.

Next, a configuration of the large-capacity stacker 110 of the image forming apparatus 101 will be described. The large-capacity stacker 110 of the image forming apparatus 101 is configured to include a communication I/F 244, a CPU 245, a memory 246, and a sheet discharge control unit 247. Those components are connected via a system bus 248. The communication I/F 244 is connected to the print apparatus 107 via the communication cable 256, and performs communication necessary for control. The CPU 245 performs various types of control necessary for discharge in accordance with a control program stored in the memory 246. The memory 246 is a storage apparatus storing a control program. Based on an instruction from the CPU 245, the sheet discharge control unit 247 performs control of conveying a conveyed sheet to a stack tray, an escape tray, or the finisher 111 that is subsequent.

Next, a configuration of the finisher 111 of the image forming apparatus 101 will be described. The finisher 111 of the image forming apparatus 101 is configured to include a communication I/F 249, a CPU 250, a memory 251, a sheet discharge control unit 252, and a finishing processing unit 253. Those components are connected via a system bus 254. The communication I/F 249 is connected to the print apparatus 107 via the communication cable 256, and performs communication necessary for control. The CPU 250 performs various types of control necessary for finishing and discharge in accordance with a control program stored in the memory 251. The memory 251 is a storage apparatus storing a control program. The sheet discharge control unit 252 controls sheet conveyance and sheet discharge based on an instruction from the CPU 250. The finishing processing unit 253 controls finishing processing such as stapling, punching, and saddle stitching based on an instruction from the CPU 250.

Next, a configuration of the external controller 102 will be described. The external controller 102 is configured to include a CPU 208, a memory 209, an HDD 210, a keyboard 211, a display 212, a LAN I/F 213, a LAN I/F 214, and a video I/F 215. Those components are connected through a system bus 216.

The CPU 208 comprehensively executes processing such as reception of print data from the client PC 103 and transmission of print data to the image forming apparatus 101 based on programs and data stored in the HDD 210. It is also possible to perform raster image processor (RIP) processing for reference image data serving as a correct answer. Specifically, in the RIP processing for reference image data, an image is generated by converting the resolution of 600 dpi to 300 dpi, for example, and in the RIP processing for print data, an image is generated not by lowering the resolution.

The memory 209 stores programs and data necessary for the CPU 208 to perform various types of processing, and operates as a work area. The HDD 210 stores programs and data necessary for operations such as print processing. The keyboard 211 is an apparatus for inputting an operation instruction of the external controller 102. The display 212 displays information such as an execution application of the external controller 102 by a video signal of a still image or a moving image. The LAN I/F 213 is connected to the client PC 103 via the external LAN 104, and performs communication such as a print instruction. The LAN I/F 214 is connected to the image forming apparatus 101 via the internal LAN 105, and performs communication such as a print instruction. The external controller 102 can mutually exchange various types of data with the print apparatus 107, the inserter 108, the image inspection apparatus 109, the large-capacity stacker 110, and the finisher 111 via the internal LAN 105 and the communication cable 256. The video I/F 215 is connected to the image forming apparatus 101 via the video cable 106, and performs communication such as print data.

Next, a configuration of the client PC 103 will be described. The client PC 103 is configured to include a CPU 201, a memory 202, an HDD 203, a keyboard 204, a display 205, and a LAN I/F 206. Those components are connected via a system bus 207. The CPU 201 executes creation and a print instruction of print data based on a document processing program or the like stored in the HDD 203. The CPU 201 comprehensively controls each device connected to the system bus 207. The memory 202 stores programs and data necessary for the CPU 201 to perform various types of processing. The memory 202 operates as a work area of the CPU 201. The HDD 203 stores programs and data necessary for operations such as print processing. The keyboard 204 is a device for inputting an operation instruction of the client PC 103. The display 205 displays information such as an execution application of the client PC 103 by a video signal of a still image or a moving image. The LAN I/F 206 is connected to the external LAN 104, and performs communication such as a print instruction and reception of an RIP image. In the present case, the toner density at the time of print is calculated by the CPU 238 of the image inspection apparatus 109, but may be received from the print apparatus 107 or the external controller 102 via the communication cable 256.

In the above description, the internal LAN 105 and the video cable 106 are connected to the external controller 102 and the image forming apparatus 101, but any configuration may be adopted as long as data necessary for print can be transmitted and received, and for example, a connection configuration with only the video cable 106 may be adopted. Each of the memory 202, the memory 209, the memory 223, the memory 234, the memory 239, the memory 246, and the memory 251 may be a storage apparatus for holding data and programs. A configuration in which those memories are substituted with, for example, a volatile RAM, a nonvolatile ROM, a built-in HDD, an external HDD, a USB memory, or the like may be adopted.

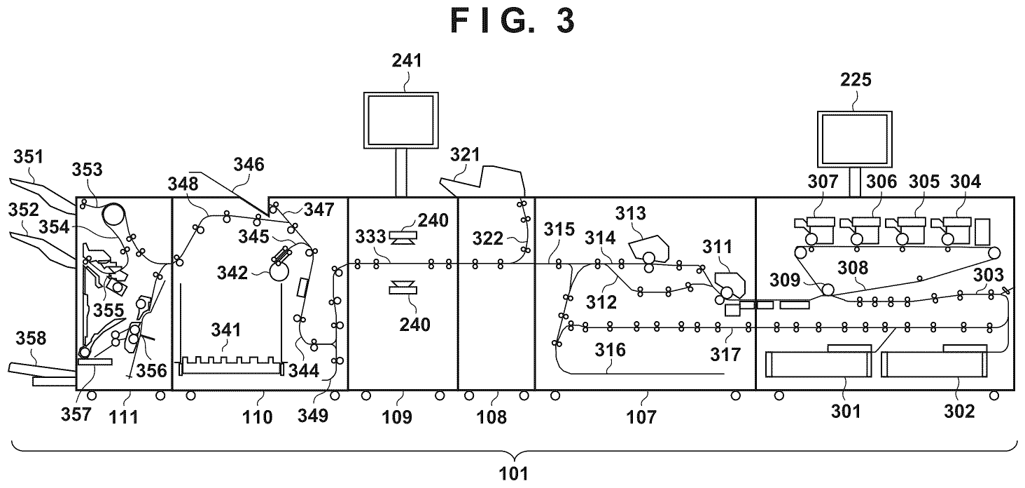

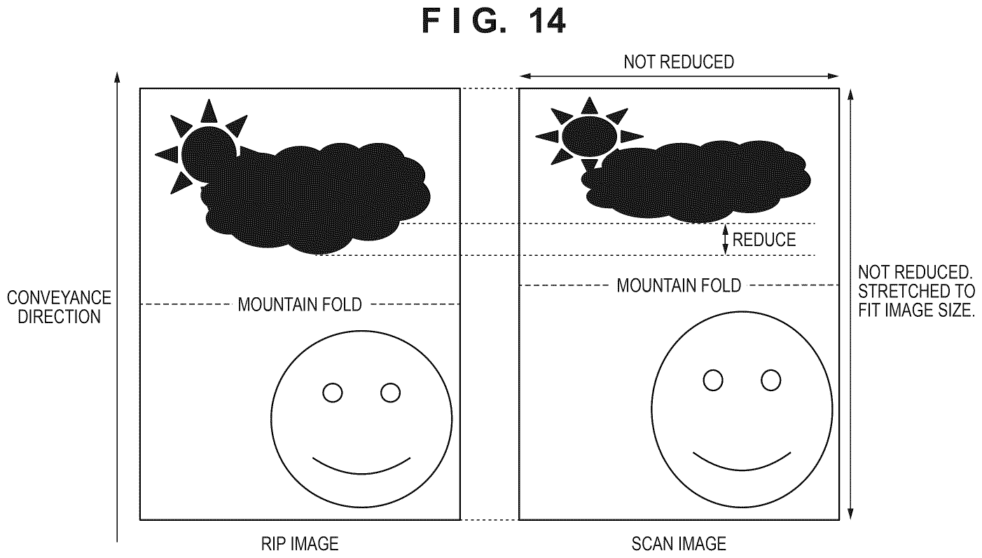

Print processing and sheet conveyance by the image forming apparatus 101 will be described with reference to FIG. 3. The print apparatus 107 forms an image to be printed on a sheet. A sheet feed deck 301 and a sheet feed deck 302 can accommodate various sheets. At each of the sheet feed decks, only the uppermost sheet of the accommodated sheets can be separated and conveyed to a sheet conveyance path 303. In order to form a color image, development stations 304 to 307 form a toner image using color toner of yellow (Y), magenta (M), cyan (C), and black (K), respectively. The toner image formed here is primarily transferred to an intermediate transfer belt 308. The intermediate transfer belt 308 rotates clockwise in FIG. 3. Then, at a secondary transfer position 309, the toner image primarily transferred to the intermediate transfer belt 308 is transferred to a sheet conveyed from the sheet conveyance path 303. At this time, if the toner density is large, slippage is likely to occur due to the toner, and the conveyance speed of the sheet may decrease. Therefore, the toner image may be reduced in the conveyance direction of the sheet, and a reduced picture as illustrated in the right view of FIG. 14 may be generated.

The display 225 displays a print status of the image forming apparatus 101 and information for setting. A fixing unit 311 fixes a toner image to a sheet. The fixing unit 311 includes a pressure roller and a heat roller, passes the sheet between the rollers, and melts and presses the toner to fix the toner image on the sheet. The sheet having passed through the fixing unit 311 is conveyed to a sheet conveyance path 315 through a sheet conveyance path 312. Depending on the type of sheet, there is a case where further melting and pressing are required for fixing. In this case, after passing through the fixing unit 311, the sheet is conveyed to a second fixing unit 313 through an upper sheet conveyance path 314. The sheet is subjected to additional melting and pressing in the second fixing unit 313, and then conveyed to a sheet conveyance path 315 through the sheet conveyance path 314. When the image forming mode is double-sided, the sheet is conveyed to a sheet inversion path 316. The sheet is inverted at the sheet inversion path 316 and then conveyed to a double-sided conveyance path 317. At the secondary transfer position 309, image transfer of the second surface of the sheet is performed.

The inserter 108 inserts an insertion sheet. The inserter 108 includes an inserter tray 321, and joins, to the conveyance path, the sheet fed through a sheet conveyance path 322. This enables an insertion sheet to be inserted into a series of sheet groups conveyed from the print apparatus 107 at an arbitrary position and to be conveyed to a subsequent apparatus.

The print sheet having passed through the inserter 108 is conveyed to the image inspection apparatus 109. The capturing unit 240 is disposed opposite a sheet conveyance path 333 of the image inspection apparatus 109. The capturing unit 240 is a sensor for scanning the upper surface of the print sheet and the lower surface of the print sheet. The image inspection apparatus 109 scans the image on the print sheet using the capturing unit 240 at a timing when the print sheet conveyed to the conveyance path 333 reaches a predetermined position. Whether the image of the print apparatus 107 is normal can be determined by executing inspection. The capturing unit 240 is one mode of a scanning unit that scans a print sheet in the present disclosure.

Specifically, the image inspection apparatus 109 inspects a sent print sheet image in accordance with an inspection item set in advance. Inspection of the print sheet image is performed by comparing a reference image serving as a correct answer set in advance with the sent print sheet image. Examples of comparison method of images include a method of comparing pixel values for each image position, a method of comparing positions of objects by edge detection, and a method of extracting character data by optical character recognition (OCR). The inspection items include a color tone of an image, density of an image, a line, thin printing, and missing print, in addition to misalignment of a print position. The display unit 241 displays an inspection result or the like performed by the image inspection apparatus 109. The print sheet having been finished with inspection by the image inspection apparatus 109 is conveyed to the large-capacity stacker 110.

The large-capacity stacker 110 is a stacker that can stack large-capacity print sheets. The large-capacity stacker 110 includes a stack tray 341 as a tray on which print sheets are stacked. The print sheet having passed through the image inspection apparatus 109 is conveyed to the large-capacity stacker 110 via a print sheet conveyance path 344. Then, the print sheet is stacked on the stack tray 341 from the print sheet conveyance path 344 via a print sheet conveyance path 345.

Furthermore, the large-capacity stacker 110 includes an escape tray 346 as a discharge tray. The escape tray 346 is a discharge tray used for discharging a print sheet determined to be an abnormality by the image inspection apparatus 109. When the print sheet is discharged to the escape tray 346, the print sheet is conveyed from the print sheet conveyance path 344 to the escape tray 346 via a print sheet conveyance path 347. When the print sheet is conveyed to the finisher 111 subsequent to the large-capacity stacker 110, the print sheet is conveyed via a print sheet conveyance path 348.

A discharge inversion unit 342 is for inverting the print sheet. This discharge inversion unit 342 is used when the print sheet is stacked on the stack tray 341. The discharge inversion unit 342 once inverts the print sheet when stacking the print sheet onto the stack tray 341 such that the orientation of the print sheet that is input and the orientation of the print sheet at the time point of output are identical. In a case of conveyance to the escape tray 346 or the finisher 111 that is subsequent, the print sheet is discharged as it is without flipping at the time of stacking, and thus, the inversion operation is not performed by the discharge inversion unit 342.

The finisher 111 applies finishing processing to a conveyed print sheet in accordance with a function designated by the user. Specifically, the finisher 111 has a finishing function such as stapling (one-point/two-point stitching), punching (two holes/three holes), and saddle stitching. The finisher 111 includes a discharge tray 351 and a discharge tray 352. The print sheet is output to the discharge tray 351 or the discharge tray 352 via a print sheet conveyance path 353 or a print sheet conveyance path 354. However, the finishing processing such as stapling cannot be performed at the print sheet conveyance path 353. In a case where the finishing processing such as stapling is performed, the finishing function designated by the user is executed by a processing unit 355 via the print sheet conveyance path 354 and the print sheet is output to the discharge tray 352. Each of the discharge tray 351 and the discharge tray 352 can move up and down, and it is also possible to operate such that the discharge tray 351 is lowered and the print sheet subjected to the finishing processing at the processing unit 355 is stacked onto the discharge tray 351. When saddle stitching is designated, a saddle stitching processing unit 356 performs stapling processing at the center of the print sheet, then folds the print sheet in two, and outputs the print sheet to a saddle stitching tray 358 via a print sheet conveyance path 357. The saddle stitching tray 358 has a belt conveyor configuration, and a saddle stitching bundle stacked on the saddle stitching tray 358 is conveyed to the left side.

### Flow of Overall Inspection Processing

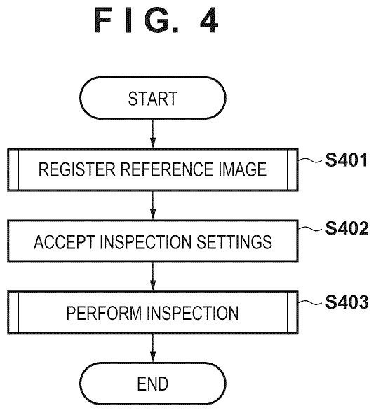

Next, the overall flow from the work before start of inspection to the execution of the inspection by the image inspection apparatus 109 will be described with reference to FIG. 4.

Each process of the flowchart of FIG. 4 is executed by the image inspection apparatus 109 in accordance with a user's operation from the operation unit 242 illustrated in FIG. 2. The processing described below is realized by, for example, the CPU 238 of the image inspection apparatus 109 reading a program stored in the HDD 255 into the memory 239 and executing the program. Hereinafter, the step number of each process included in the flowchart is indicated by a number starting with “S”. The same applies to the subsequent flowcharts.

First, in S401, the CPU 238 registers a reference image serving as a correct answer of the inspection. A simulation image using print data received in advance via the communication I/F 237 (hereinafter, a simulation reference image) or scan data captured by the image inspection apparatus 109 in advance is used as the reference image. The simulation reference image is an image created by adding color conversion, noise reproduction, reproduction processing of reflection, addition of a margin, and the like to the print data, and is an image simulated by predicting scan data from the print data. Feature points are acquired from the reference image here and stored in the HDD 255 together with the reference image.

In S402, the CPU 238 sets detailed inspection area settings such as the inspection level, the inspection type, and the inspection area of print image inspection in accordance with a user's operation. These settings are set using an inspection UI of FIG. 12. Various types of setting content of FIG. 12 will be described later.

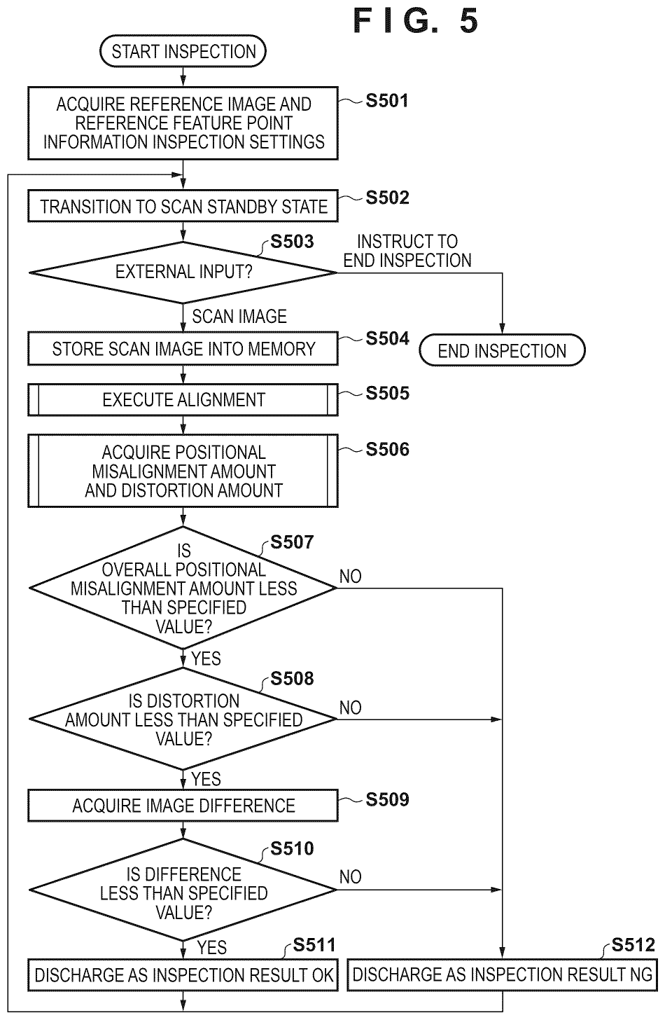

Next, in S403, inspection is executed. The inspection processing in S403 will be described in detail with reference to the flowcharts in and after FIG. 5.

### Inspection

Next, a flow of inspection will be described.

Once the inspection is started, in S403, the CPU 238 inspects the print sheet based on the reference image registered in S401 and the inspection setting set in S402. A flow of scanning an image and performing inspection will be described with reference to FIG. 5. The processing described below is realized by, for example, the CPU 238 of the image inspection apparatus 109 reading a program stored in the HDD 255 into the memory 239 and executing the program.

In S501, the CPU 238 acquires the inspection setting and information on the reference image and the feature points.

In S502, the CPU 238 transitions to a scan standby state. What is received in the scan standby state is two types of external input of scan of an inspection image and an inspection end instruction.

If the inspection end instruction is received in S503, the inspection processing is ended. If the input of the scan of the inspection image is received, on the other hand, the process proceeds to S504.

In S504, the CPU 238 stores the inspection image scanned using the capturing unit 240 into the memory 239 of the image inspection apparatus 109. When the CPU 238 is in the scan standby state, the capturing unit 240 stands by in a state where the print sheet can be always scanned. When the print apparatus 107 executes print on the sheet and the print sheet passes through the capturing unit 240, the capturing unit 240 scans the print sheet to acquire an inspection image. The inspection image obtained by the scan is sent to the CPU 238. Then, the process proceeds to S505.

In S505, the CPU 238 executes alignment between the reference image and the inspection image stored in the memory 239. In the alignment, first, rigid alignment of the inspection image is performed by affine transformation using the feature points of the reference image and the inspection image. In this alignment, a misalignment occurring at the formation position of an image when the image is formed on a sheet is aligned with the reference image.

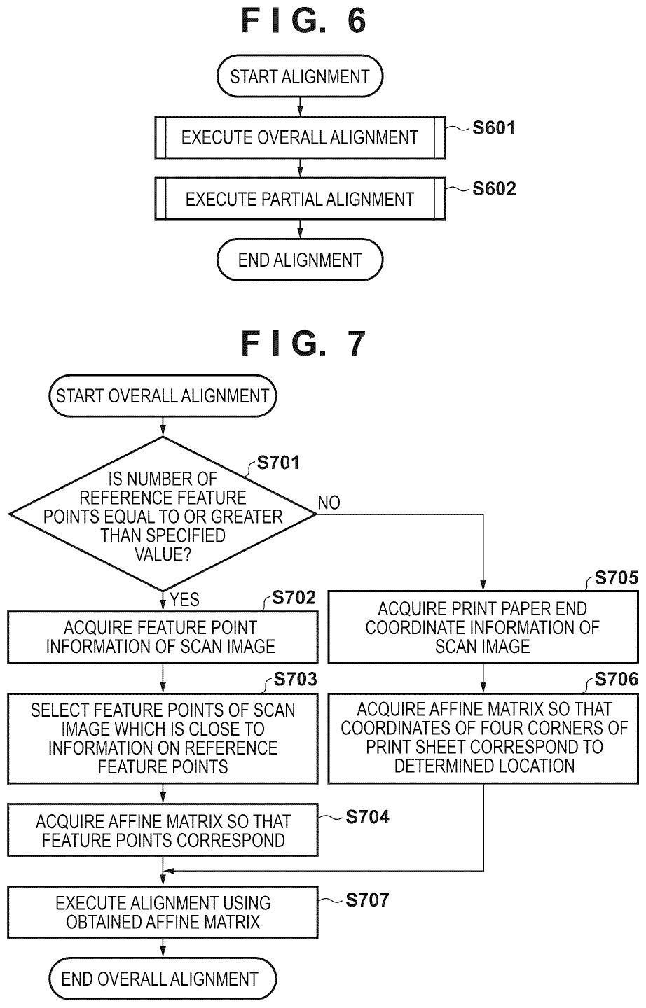

Thereafter, the positional misalignment due to distortion of the print sheet is removed by non-rigid alignment. Alignment of the positional misalignment due to distortion uses free form deformations (FFD) as an example. Details of the alignment will be described later with reference to FIG. 6 and subsequent drawings. Here, “distortion” in the present embodiment is defined as a local non-linear positional misalignment that cannot be aligned in an image on which rigid alignment of the inspection image has been performed (image in which the formation position is aligned overall).

Subsequently, in S506, the CPU 238 acquires the “overall positional misalignment amount” quantitatively representing the misalignment width when the rigid alignment is performed in S505 and the “distortion amount” quantitatively defining distortion. The “overall positional misalignment amount” indicates a distance of the four corners of the sheet between the reference image and the inspection image, and the “distortion amount” indicates a distance between corresponding pixels between the reference image and the inspection image. The distortion amount will be described later with reference to FIG. 9 and subsequent drawings.

In S507, the CPU 238 determines whether the overall positional misalignment amount is less than a specified value, and if it is less than the specified value, determines the inspection result to be normal. If the CPU 238 determines the inspection image to be normal in S507, the process proceeds to S508. If the overall positional misalignment amount of the inspection image is the specified value or more, the CPU 238 determines the inspection result to be an abnormality, and the process proceeds to S512. In S512, the CPU 238 instructs the large-capacity stacker 110 to discharge the print sheet determined to be an abnormality to the escape tray 346 as an abnormal sheet. Note that the specified value of the overall positional misalignment amount is set at the time of inspection setting, and this will be described later.

In S508, the CPU 238 determines whether the distortion amount of the inspection image is less than a specified value, and if it is less than the specified value, determines the inspection result to be normal. If the CPU 238 determines the inspection image to be normal in S508, the process proceeds to S509. When the distortion amount of the inspection image is the specified value or more, the inspection result is determined to be an abnormality, and the process proceeds to S512. In S512, the CPU 238 instructs the large-capacity stacker 110 to discharge the print sheet determined to be an abnormality to the escape tray 346 as an abnormal sheet. Note that the specified value of the distortion amount is set at the time of inspection setting, and this will be described later.

Subsequently, in S509, the CPU 238 performs abnormality inspection of the image on which an abnormality of the image in a picture is detected. The abnormality inspection of the image performed here detects an abnormality of the image such as a dot or a line described later with reference to FIG. 12. An image difference between the reference image and the inspection image is acquired, and an abnormality of the image is extracted based on the image difference. Extraction of an abnormality includes performing fine modification by comparison with a neighboring pixel by window matching, correction of density variation with respect to an image difference, and correction in which the difference of the edge peripheral portion is weighted with an edge intensity, and performing, on them, emphasis processing in accordance with the shape of the abnormality. A corrected difference image thus generated is subjected to binarization processing with a threshold, and one having a threshold or more is determined to be an abnormality.

In S510, the CPU 238 determines whether the inspection result of the inspection image is normal based on the existence or absence of the abnormality detected in S509. If it is determined to be normal in S510 (in a case of Yes), the process proceeds to S511. In S511, the image inspection apparatus 109 instructs the large-capacity stacker 110 to discharge the print sheet determined to be a normal image to the stack tray 341. If it is determined in S510 that there is an abnormality of a specified level or more (in a case of No), on the other hand, the print sheet is determined to be an abnormal sheet, and the process proceeds to S512. In S512, the image inspection apparatus 109 instructs the large-capacity stacker 110 to discharge, to the escape tray 346, the print sheet as an abnormal sheet.

Thus, after executing the alignment, the image inspection apparatus 109 can check the overall positional misalignment amount and the distortion amount, determine the existence or absence of an abnormality of the image, and sort the sheets into the discharge destinations. Next, an execution flow of alignment will be described with reference to FIG. 6. The processing described below is realized by, for example, the CPU 238 of the image inspection apparatus 109 reading a program stored in the HDD 255 into the memory 239 and executing the program.

### Alignment

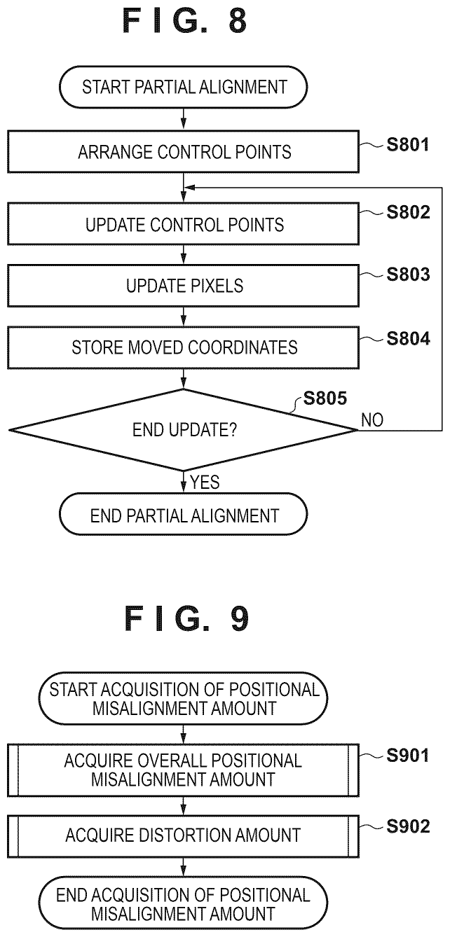

The alignment in S505 is roughly divided into two steps. First, in S601, the CPU 238 performs overall alignment (first alignment) that is linear alignment between the scanned inspection image and the reference image. The flow of the overall alignment will be described later with reference to FIG. 7 and subsequent drawings. Distortion that is a local non-linear positional misalignment that cannot be aligned by the overall alignment remains between the inspection image aligned by the overall alignment in S601 and the reference image. Then, in S602, the CPU 238 performs partial alignment (second alignment) for aligning the position of the locally generated distortion. The flow of the partial alignment will be described later with reference to FIG. 8 and subsequent drawings.

Now, the overall alignment in S601 of FIG. 6 will be described with reference to FIG. 7. The processing described below is realized by, for example, the CPU 238 of the image inspection apparatus 109 reading a program stored in the HDD 255 into the memory 239 and executing the program.

In S701, the CPU 238 counts the number of feature points acquired in S501. Here, if the number of feature points is less than a specified value (in a case of No), it is determined that there is a high possibility that the alignment using the feature points will fail, and the process proceeds to S705. On the other hand, if the number of feature points is a specified value or more in S701, the process proceeds to S702, and alignment using feature points is executed. For example, the specified value of the number of feature points here is 3, which is the minimum number for generating a single affine matrix. The specified value of the number of feature points may be increased in order to improve accuracy, and the specified value of the number is not limited to the above.

Next, in S702, the CPU 238 extracts feature points from the inspection image. In the feature point extraction of the present case, a grayscale image is generated, and feature points having a threshold or more are selected from among the feature points extracted by the Harris corner detection method and are set as feature points. In the present embodiment, the Harris corner detection method is used, but the method of feature point extraction is not limited to this.

Subsequently, in S703, the CPU 238 performs matching between the feature points of the inspection image extracted in S702 and the feature points of the reference image acquired in advance, and selects the feature points to be used for alignment between the inspection image and the reference image.

In S704, the CPU 238 acquires an affine matrix that performs alignment so that the feature points of the reference image and the feature points of the inspection image obtained in S703 correspond to each other.

In S701, if proceeds to S705 due to an insufficient number of feature points, the CPU 238 executes the overall alignment using the four corners of the print sheet of the inspection image. In S705, the CPU 238 acquires the coordinates of the four corners of the print sheet of the inspection image.

Subsequently, in S706, the CPU 238 acquires an affine matrix so as to move the four corners of the print sheet of the inspection image to determined coordinates, respectively. At this time, the determined coordinates indicate the four corner positions of the print sheet of the reference image. In the present embodiment, a simulation reference image is used as a reference image, and the four corner coordinates of the print sheet of the reference image are determined at the stage of creating the simulation reference image. Therefore, the determined coordinates are constants depending only on a sheet size.

Finally, in S707, the CPU 238 executes overall alignment by performing affine transformation on the inspection image using the affine matrix acquired in the step of S704 or S706. This can acquire an overall alignment image I in which the inspection image is aligned with the reference image. This overall alignment image I is an image in which a misalignment between the printed image and the coordinates of the sheet on the print sheet is removed from the inspection image, the misalignment caused by unevenness in the scanning start timing and the conveyance speed of the print sheet.

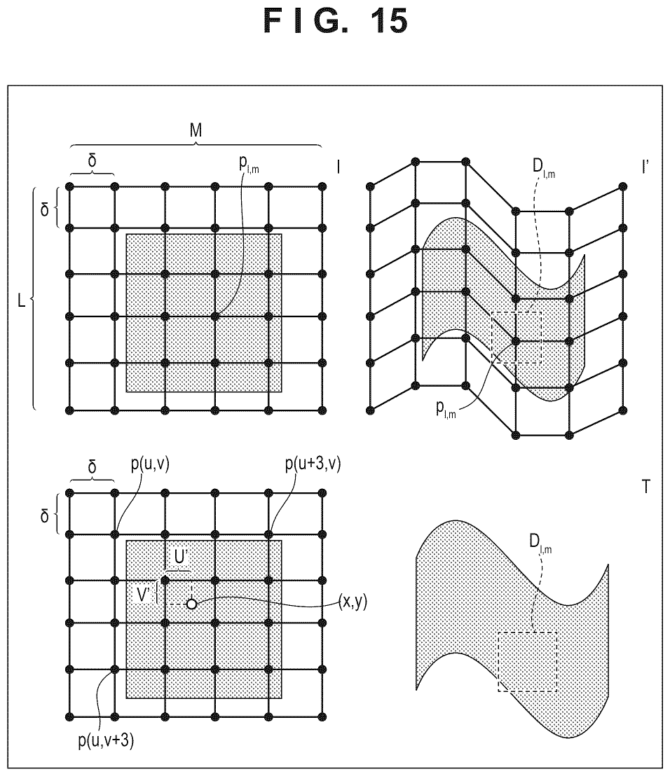

Subsequently, the partial alignment in S602 of FIG. 6 will be described with reference to FIG. 8. The processing described below is realized by, for example, the CPU 238 of the image inspection apparatus 109 reading a program stored in the HDD 255 into the memory 239 and executing the program. The partial alignment uses a non-rigid alignment technique such as free form deformations (FFD) as an example (FIG. 15), but other common misalignment may be used.

In the partial alignment, first, in S801, the CPU 238 arranges L×M control points in a grid shape with respect to the overall alignment image I. At this time, a distance δ between the control points is obtained from L, M, and the image size. Let the coordinates of a control point at row 1, column m be p_{l,m} (l=1, . . . , L, m=1, . . . , M).

Subsequently, in S802, the CPU 238 updates the control points. The update expression is shown in Expression (1). μ represents a weight coefficient, and may be a value such as 0.1, for example, or may be changed according to the control point update speed. ∇c is a derivative value of the sum of squares of the difference between the pixel values of I′ and T in a set D_{l,m} of positions of pixels present in the vicinity of the control point p_{l,m} shown in Expression (2).

$${p}_{l , m} = {p}_{l , m} + μ \frac{∇ c}{‖ ∇ c ‖} \qquad ( 1 )$$

$$∇ c = \frac{\partial }{\partial {p}_{l , m}} {\sum }_{{D}_{l , m}} {\vert {I}^{′} ( x , y ) - T ( x , y ) \vert}^{2} \qquad ( 2 )$$

Subsequently, in S803, the CPU 238 updates the pixels. The update expression is shown in Expression (3). The image after alignment processing is referred to as the aligned image I′. W(x, y) is expressed by Expression (4), and is an expression for acquiring the coordinates after alignment processing of coordinates (x, y) in an inspection target image. The basis B₀(t), B₁(t), B₂(t), and B₃(t) in Expression (4) are expressed by Expressions (5), (6), (7), and (8), respectively. Here, as illustrated in FIG. 15,

$$u = ⌊ \frac{x}{δ} ⌋ - 1 , v = ⌊ \frac{y}{δ} ⌋ - 1 , {u}^{′} = \frac{x}{δ} - ⌊ \frac{x}{δ} ⌋ - 1 , {v}^{′} = \frac{y}{δ} - ⌊ \frac{y}{δ} ⌋$$

Note that the present embodiment has 16 grid points of p(u, v) p(u+1, v), . . . p(u+3, v+3) used for acquiring pixels in the aligned image I′, but the present disclosure is not limited to this. Four grid points having close Euclidean distances of (x, y), for example, may be adopted.

$${I}^{′} ( x , y ) = I ( w ( x , y ) ) \qquad ( 3 )$$

$$w ( x , y ) = {\sum }_{i = 0}^{3} {\sum }_{j = 0}^{3} {B}_{i} ( {u}^{′} ) {B}_{j} ( {v}^{′} ) {p}_{u + i , v + j} \qquad ( 4 )$$

$${B}_{0} ( t ) = {( 1 - t )}^{3} / 6 \qquad ( 5 )$$

$${B}_{1} ( t ) = ( 3 {t}^{3} - 6 {t}^{2} + 4 ) / 6 \qquad ( 6 )$$

$${B}_{2} ( t ) = ( - 3 {t}^{3} + 3 {t}^{2} + 3 t + 1 ) / 6 \qquad ( 7 )$$

$${B}_{3} ( t ) = {t}^{3} / 6 \qquad ( 8 )$$

In S804, the CPU 238 stores the coordinates (x, y) in the inspection target image and moved coordinates as a look up table (LUT) at each point moved in S803, and an alignment locus of each point can be tracked.

In S805, the CPU 238 determines whether the update is completed. The determination as to whether the update is completed may be made by calculating a distance d between the aligned image I′ and a reference image T and using a threshold. Where

$$d = \frac{1}{XY} {\sum }_{x = 1}^{X} {\sum }_{y = 1}^{Y} \vert {I}^{′} ( x , y ) - T ( x , y ) \vert . \qquad ( 9 )$$

When d becomes the threshold or less, the update processing is completed.

Thus, each pixel is updated, and the alignment is ended. This can perform partial alignment of the overall alignment image with the reference image and acquire a partial alignment image. With the partial alignment image, it is possible to obtain an image from which distortion that is a positional misalignment having not been aligned by the overall alignment has been removed, and to inspect an image abnormality by pixel comparison.

### Acquisition of Positional Misalignment Amount and Distortion Amount

Subsequently, in S506, the CPU 238 acquires the positional misalignment amount using intermediate data acquired at the time of alignment. An acquisition flow of the positional misalignment amount is as shown in FIG. 9. The processing described below is realized by, for example, the CPU 238 of the image inspection apparatus 109 reading a program stored in the HDD 255 into the memory 239 and executing the program. In S901, the CPU 238 acquires the overall positional misalignment amount, and in S902, the CPU 238 acquires the distortion amount having not been aligned by the overall alignment and having been aligned by the partial alignment.

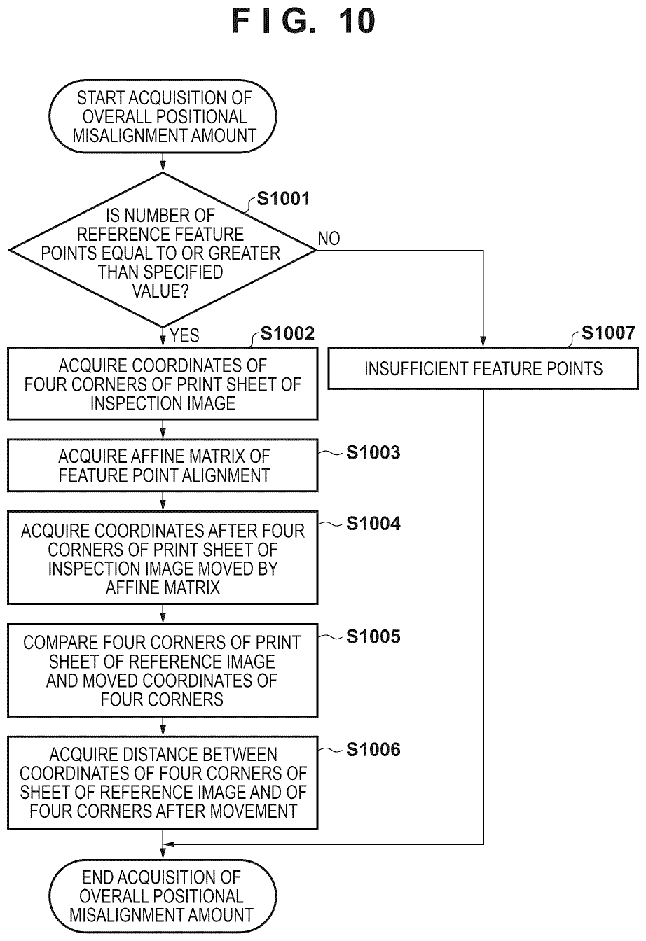

FIG. 10 shows a flow of acquisition of the overall positional misalignment amount. The processing described below is realized by, for example, the CPU 238 of the image inspection apparatus 109 reading a program stored in the HDD 255 into the memory 239 and executing the program.

In S1001, the CPU 238 determines whether the number of feature points of the reference image is a specified value or more. If the number of feature points of the reference image is less than the specified value, the processing proceeds to S1007 as an insufficient number of feature points, and acquisition processing of the overall positional misalignment amount is not performed. If the number of feature points is a specified value or more in S1001, the processing proceeds to S1002, and the acquisition processing of the overall positional misalignment amount is started.

First, in S1002, the CPU 238 acquires the coordinates of the four corners of the print sheet from the scanned inspection image.

Next, in S1003, the CPU 238 acquires a feature point affine matrix obtained in S704.

Subsequently, in S1004, the CPU 238 performs affine transformation on the coordinates of the four corners of the print sheet of the inspection image using this feature point affine matrix. This can align the four corner positions of the print sheet with the four corner positions of the reference image. Strictly speaking, the image printed on the print sheet is not printed according to the reference image of the correct answer, and therefore, when the four corner coordinates are aligned, there is a positional misalignment between the print image and the reference image. In the reference image and the image after the feature point affine transformation, a positional misalignment occurs at the coordinates of the four corners of the print sheet. That is, the feature point alignment and the alignment by the four corner coordinates do not have the same alignment result due to the influence of the overall positional misalignment.

Here, in S1005, the CPU 238 obtains a difference between the four corner positions of the print sheet of the correct answer image and the four corner positions of the print sheet after the feature point affine transformation obtained in S1004. This serves as a vector indicating the overall positional misalignment.

In S1006, the CPU 238 obtains respective absolute values for the four vectors at the four corners indicating the overall positional misalignment. The largest one among them is selected, and this is defined as the overall positional misalignment amount.

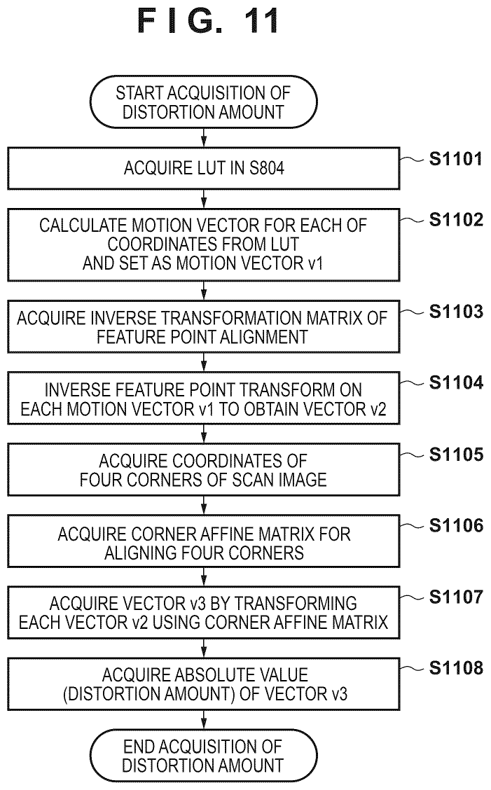

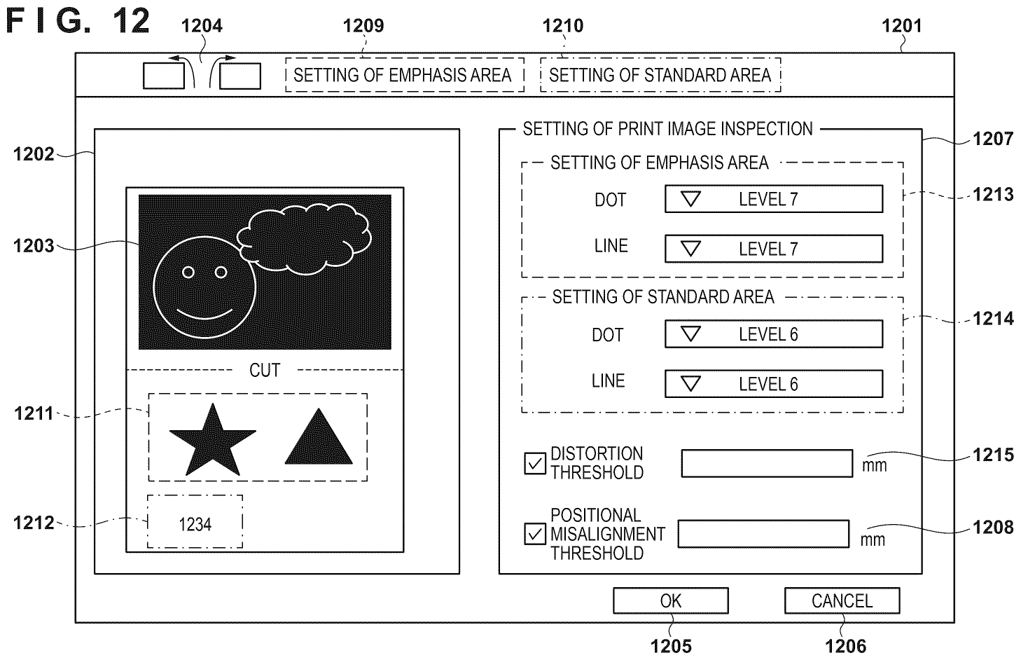

Next, a flow of acquiring the distortion amount will be described with reference to FIG. 11. The processing described below is realized by, for example, the CPU 238 of the image inspection apparatus 109 reading a program stored in the HDD 255 into the memory 239 and executing the program.

In S1101, the CPU 238 acquires the LUT stored in S804.

Next, in S1102, the CPU 238 acquires coordinates of a destination to which each pixel of the inspection image scanned from the LUT is finally moved, and defines this motion vector as a motion vector v1. This motion vector v1 can be regarded as indicating distortion, but it is the scale of the image after the feature point affine transformation, and therefore the motion vector v1 is normalized in order to adjust the scale to the reference image in the present example.

Then, in S1103, the CPU 238 acquires the feature point affine matrix acquired in S704, and obtains an inverse transformation matrix of the feature point affine matrix.

Then, in S1104, the CPU 238 applies the vector v1 with transformation by the inverse transformation matrix obtained in S1103 and obtains a vector v2. This is what scaling by the feature point affine transformation is removed from the motion vector v1, but it has a scaling error generated at the time of conveyance, and therefore scaling in the sheet size is finally performed.

In S1105, the CPU 238 acquires the four corner coordinates of the print sheet of the inspection image.

Subsequently, in S1106, the CPU 238 obtains a four corner affine matrix for aligning the four corner coordinates of the print sheet of the inspection image with the four corner positions of the print sheet of the reference image.

Then, in S1107, the CPU 238 can perform scaling by the sheet size by transforming the vector v2 by the four corner affine matrix obtained in S1106. This vector is defined as a distortion vector v3.

Finally, in S1108, the CPU 238 obtains the absolute value for the distortion vector v3. The absolute value of the distortion vector v3 can be said to be the distortion amount of each pixel. The maximum one of among the distortion amounts is defined as the distortion amount in the inspection image. Although the processing of S1103 to S1107 is performed here, the difference in the distortion amount caused by this scaling is not large, and therefore the processing may be omitted, the vector v1 and the vector v2 may be distortion vectors, and the absolute values thereof may be the distortion amounts.

### Inspection Setting

Hereinafter, a flow of inspection setting by a user interface (UI) that performs setting of inspection will be described with reference to FIG. 12.

A screen 1201 indicates a window of an inspection UI, and the user performs inspection area setting of an emphasis area, a standard area, and a distortion inspection area. The emphasis area is an area where inspection of an image abnormality is performed particularly intensively as compared with other areas such as a human face. The standard area is an area where inspection is standardly performed. The distortion inspection area is an area where distortion is particularly inspected. In the present embodiment, three types of inspection area setting will be described as an example, but the area name, the area type, and the number of areas are not limited to this.

An area 1202 is an area where preview of an image is performed. Here, the reference image registered in S401 is displayed. The above-described inspection area setting is made by selecting an area on this reference image.

An area 1203 indicates an inspection area. In the area 1203, the type of line surrounding the area is drawn with the same type of line as the above-described four types of inspection area setting. For example, an area 1211 surrounded by a dotted line in the area 1203 is an emphasis area. An area 1212 surrounded by a dash-dot line is a standard area.

A button 1204 indicates a rotation function. It is possible to rotate a 90° preview screen by operating the button 1204. As in the figure, there are two buttons 1204, and clockwise rotation and counterclockwise rotation can be selected, respectively.

A button 1205 indicates an OK button. It is possible to store the inspection area setting by operating the OK button.

A button 1206 indicates a cancel button. When the cancel button is operated, the inspection area setting having been input is discarded.

An area 1207 is a UI for setting the inspection level. It is possible to set two inspection area setting in the frame of the area 1207, setting of the emphasis area, setting of the standard area, and a threshold serving as a reference of each inspection level, distortion, and positional misalignment. The area of the inspection setting in the preview area 1202 is indicated by a line of a type used for the frame of the inspection area in the frame of each area 1207.

A setting frame 1215 of distortion inspection sets a maximum allowable misalignment amount of distortion with respect to the inspection image.

A positional misalignment threshold 1208 indicates an overall positional misalignment amount allowable when the overall positional misalignment occurs.

Hereinafter, a method of performing inspection setting will be described with reference to FIG. 12.

When performing the inspection setting of the image inspection, the user sets an area where the inspection is performed for the reference image displayed in the preview area 1202. Here, the user uses a setting button 1209 of the emphasis area and a setting button 1210 of the standard area. The user can set an area that is an inspection target such as the areas 1211 and 1212 by selecting a button corresponding to the type of inspection to be performed and selecting, with a quadrangle, a specific area of the reference image in the preview area. At this time, a line of the same type as the selected button is displayed as a frame line of the set area.

Subsequently, the user sets a reference value of inspection for each selected area. In a setting frame 1213 of the emphasis area and a setting frame 1214 of the standard area, the reference value for each area can be set. Here, the image abnormality to be set is an abnormality (dot) of a round shape and an abnormality (line) of a linear shape. The inspection level is a parameter for setting, for each stage, the size from which the abnormality is determined for each of the features of the abnormality having been detected. For example, the inspection level has seven stages from level 1 to level 7, and an abnormality having a thinner and smaller size can be detected more in level 7 than in level 1. A different level can be set for each inspection item, such as an inspection level 7 for a dot and an inspection level 4 for a line.

For the area selected as the emphasis area in the button 1209, an inspection reference value is set in the setting frame 1213. The user can select the inspection level by pull-down for each of the dot and the line. For the area selected as the standard area in the button 1210, an inspection reference value is set in the setting frame 1214. The user can select the inspection level by pull-down for each of the dot and the line.

Note that the parameter setting and the number of stages of the level are not limited to this. The setting of the emphasis area in FIG. 12 indicates that the user has selected level 7 for the inspection level setting of the dot, and level 7 for the inspection level setting of the line. The setting of the standard area indicates that the user has selected level 6 for the inspection level setting of the dot, and level 6 for the inspection level setting of the line.

For the positional misalignment inspection, the user can inspect the overall positional misalignment by checking a check box of the overall positional misalignment threshold 1208 and inputting the allowable maximum value in units of mm in the frame. The overall positional misalignment inspection is executed only when the check box of the overall positional misalignment threshold 1208 is checked. When the check box is unchecked, the overall positional misalignment inspection is not performed. An image inspection method of the overall positional misalignment amount is performed similarly to that of the overall positional misalignment amount described in FIG. 10, and it is determined that there is an overall positional misalignment when there is an overall positional misalignment exceeding the maximum value allowable in the inspection image.

For the distortion inspection, the user sets a distortion threshold serving as an inspection reference value in the setting frame 1215. The user describes the distortion threshold in units of mm in the frame. When the user checks the check box of the distortion threshold and inputs a numerical value as a distortion threshold, the distortion amount in the print sheet is obtained by the flow described in FIG. 11. If the distortion amount of the sheet exceeds the input distortion threshold, it is determined that there is distortion. The distortion inspection is executed only when the check box of the distortion threshold 1215 is checked. If the check box is unchecked, distortion inspection is not performed.

After finishing input to each setting item, the user completes the inspection setting by operating the button 1205. The inspection setting having been input is stored in the HDD 255.

### Presentation of Result

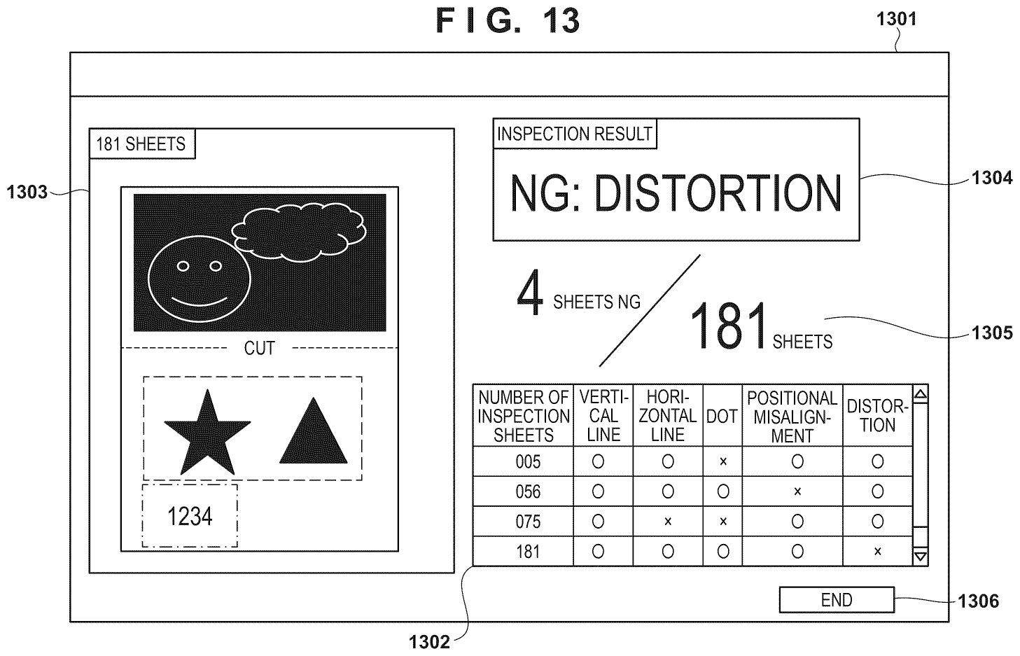

Display of the UI screen and the inspection result on the display unit 241 will be described with reference to FIG. 13. The UI in FIG. 13 can be confirmed both during the inspection and after the inspection ends.

1301 denotes an inspection result window. On this window, the user can confirm the inspection result of the print sheet for which the inspection that has ended.

An inspection result list 1302 displays a result of the inspection that has already ended. The inspection result list 1302 displays a list of sheets determined to be abnormal sheets by the inspection among the print sheets. The user can confirm details of the inspection result by selecting an abnormal sheet desired to confirm from the inspection result list 1302 by clicking or the like. The inspection result list 1302 displays a list of causes of determination as abnormal sheets, and it is possible to distinguish five types of vertical lines, horizontal lines, dots, positional misalignment, and distortion by ◯×. Note that the present disclosure is not intended to be limited, and may be expressed using “YES” or “NO”, or other arbitrary character strings or symbols.

An inspection image display screen 1303 displays an image of an abnormal sheet. Among inspection images, an image determined to be an abnormal sheet is stored in the HDD 255. When the user selects a sheet from the abnormal sheets in the inspection result list 1302, the inspection image display screen 1303 is switched to the abnormal sheet selected by the user, and the inspection image of the selected sheet is displayed.

An inspection result 1304 displays why the selected abnormal sheet is determined to be an abnormality. The type of the cause of the abnormality displayed in the inspection result 1304 matches the item in the inspection result list 1302. In addition to vertical lines, horizontal lines, and dots, there are positional misalignment and distortion. The positional misalignment indicates overall positional misalignment. The inspection result 1304 displays the type of abnormality that has × in the inspection result list 1302. If a plurality of causes have been found, all the causes are displayed.

Inspection progress 1305 indicates the current inspection progress. The inspection progress 1305 displays the number of sheets for which the inspection has ended in the denominator and the number of sheets determined to be an abnormality in the inspection in the numerator. The example of FIG. 13 indicates that inspection of 181 sheets has ended and 4 sheets of them have been an abnormality (NG).

An end button 1306 is a button for closing the inspection result window 1301, and when the user operates the end button 1306, the inspection result window 1301 is closed. When the end button 1306 is operated during inspection, the print apparatus 107 inspects all the sheets up to the sheet on which printing has been currently started, then ends the inspection, and closes the inspection result window 1301.

Thus, according to the present embodiment, it is possible to determine the distortion amount having not been aligned by the overall alignment and having been aligned by the partial alignment, and to inspect whether the sheet is normal or an abnormality based on the distortion amount.

### Second Embodiment

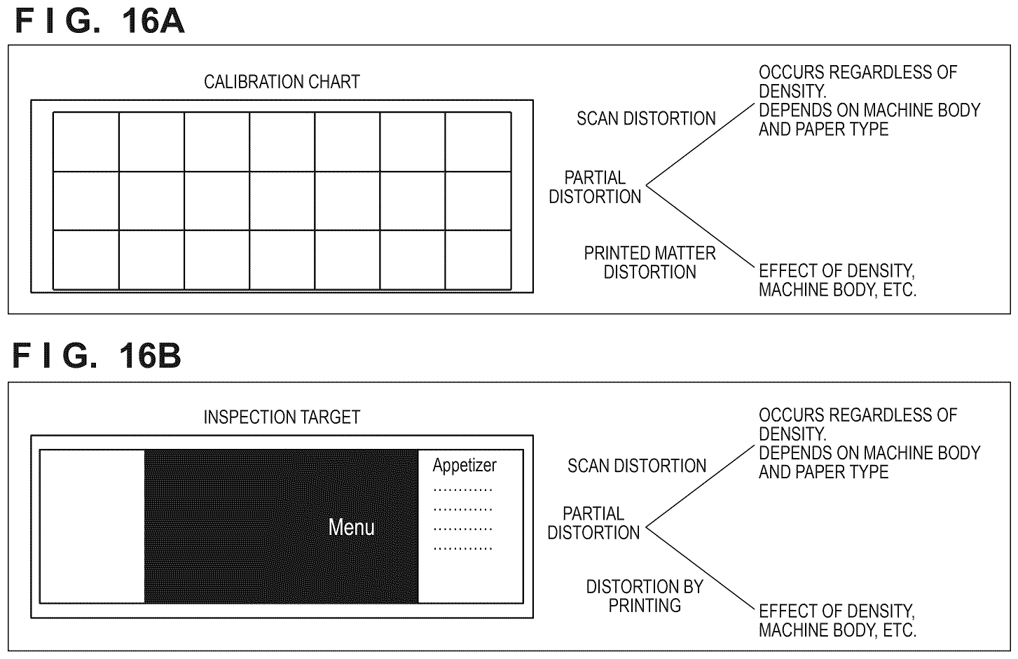

According to the first embodiment, it is possible to determine whether the print sheet is normal or an abnormality by determining the distortion amount by partial alignment between the inspection image and the reference image. However, according to strict analysis on the distortion of the inspection image, as illustrated in FIG. 16B, there are distortion caused by the toner density of the print sheet itself by print and distortion caused by scan of the print sheet by the capturing unit 240 at the time of inspection. The distortion of the print sheet by print is distortion as described in the background, and is affected by the toner density of the print, the machine body, the paper type, and the like.

On the other hand, distortion caused by scan of the print sheet by the capturing unit 240 is generated by a local change in the conveyance speed due to a speed difference of the rollers or the like at the time of conveyance, and the manner of distortion tends to be the same for each sheet type and each machine body of print. This distortion is distortion having not occurred in the print sheet, but is distortion occurring in a scanned image. The distortion by scan by the capturing unit 240 is distortion not seen on the print sheet, and therefore when a scanned print sheet is an inspection target, there is a case of determining that there is distortion even though there is no distortion on the print sheet itself. Therefore, the distortion amount from which an influence of a scan-derived distortion amount is removed is adopted as the distortion amount acquired in the second embodiment, and the distortion amount is determined only by the distortion of the print sheet. A flow in which the influence of scan distortion of the present embodiment is removed is redefined as a distortion amount and used for inspection will be described with reference to FIGS. 16A, 16B, 17, and 18.

The second embodiment uses a calibration chart as shown in FIG. 16A. The calibration chart is printed by the print apparatus 107 and scanned by the capturing unit 240 to acquire a scanned image. The present calibration chart is designed so that the toner density is small and uniform, and distortion due to print hardly occurs. Therefore, distortion detected in the scan image when the present calibration chart is scanned can all be distortion by scan.

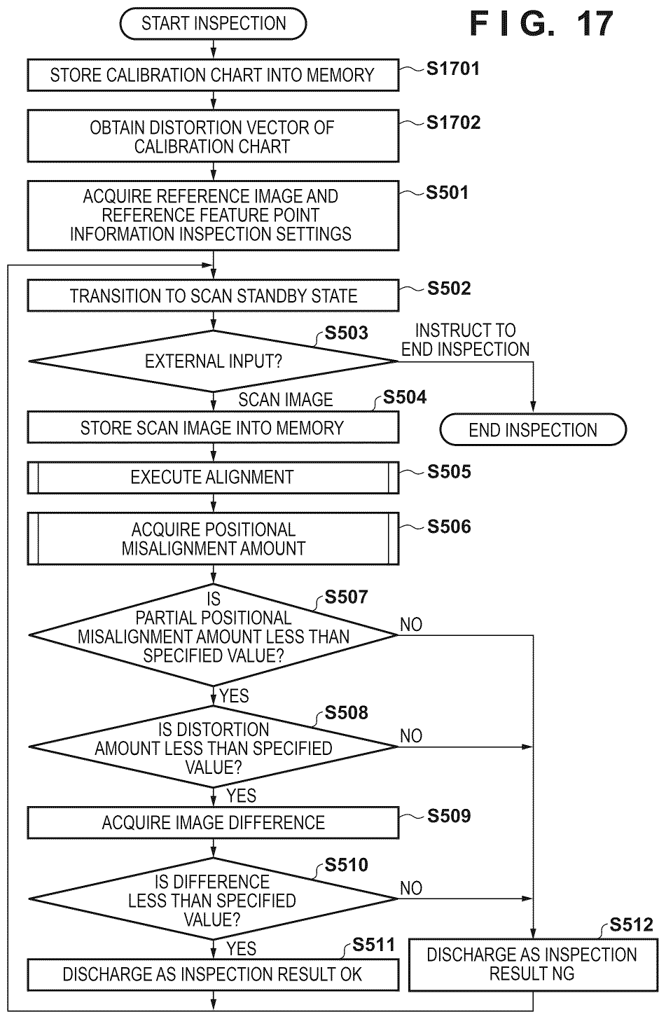

Processing of removing the influence of the scan distortion from the distortion amount of the print sheet using the calibration chart will be described with reference to FIG. 17. The processing described below is realized by, for example, the CPU 238 of the image inspection apparatus 109 reading a program stored in the HDD 255 into the memory 239 and executing the program.

In S1701, the print apparatus 107 prints the calibration chart, and the CPU 238 holds the calibration chart captured by the capturing unit 240 in the memory 239.

Subsequently, in S1702, the CPU 238 obtains a distortion vector in the calibration chart. The distortion vector in the calibration chart is acquired by a similar technique to the distortion vector v3 of the flow described in FIG. 11. The distortion vector v3 obtained by the calibration chart is defined as a calibration vector v4. Then, the coordinates of the scan image and the calibration vector v4 thus obtained are associated with each other as LUT and held.

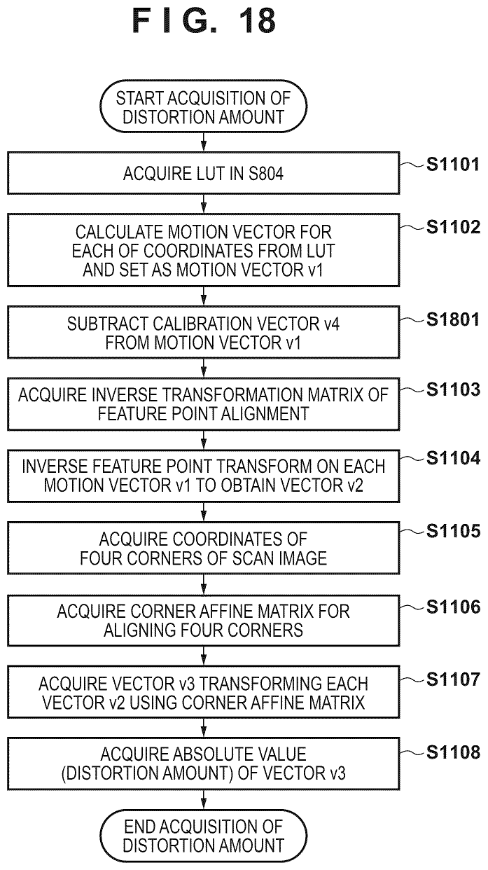

FIG. 18 is a flow in which S1801 for removing distortion by scan is added to the flow of FIG. 11. As shown in S1801 of FIG. 18, the CPU 238 subtracts a movement amount by scan distortion by subtracting the calibration vector v4 from the motion vector v1 indicating the final movement amount of each pixel of the scanned inspection image. As described above, the influence of the distortion generated at the time of scanning can be excluded from the distortion amount, and inspection of the print distortion in the print sheet is possible.

### Third Embodiment

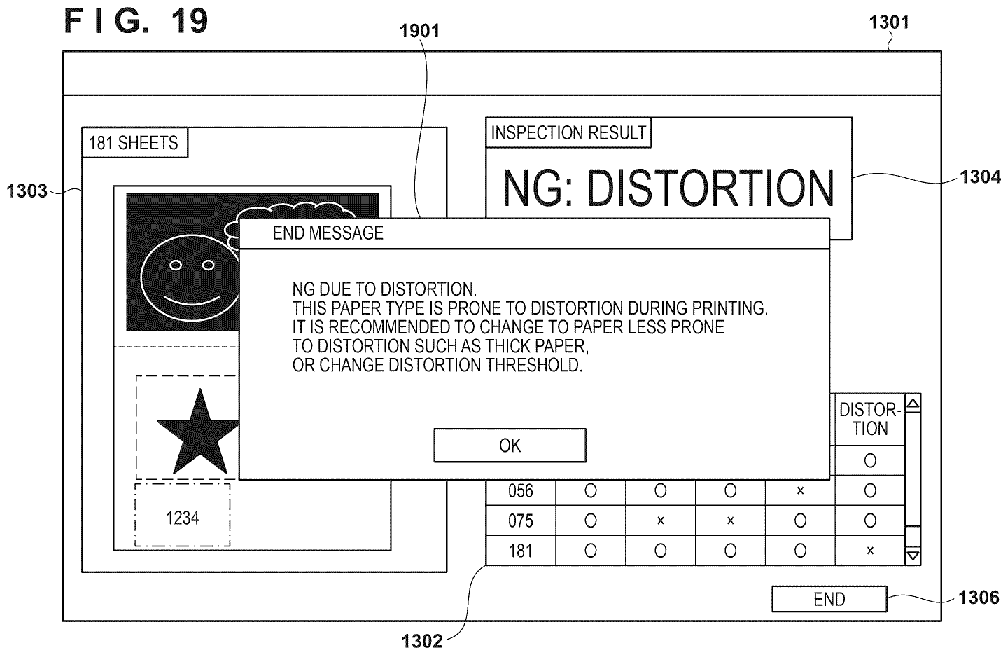

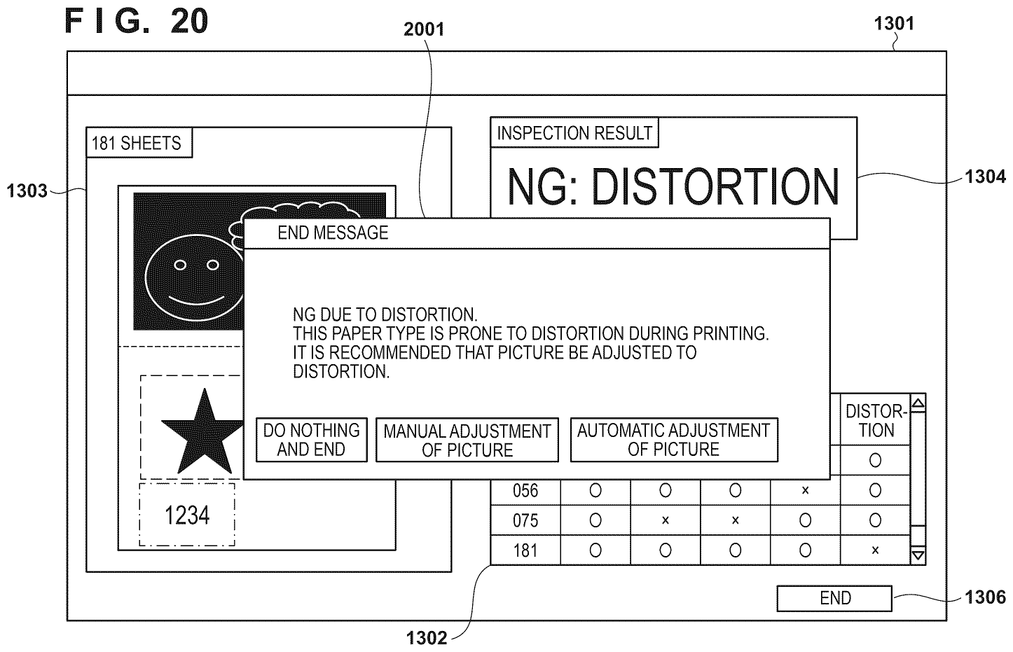

According to the first embodiment, it has been described as to whether to determine a sheet to be normal or an abnormality by the distortion amount placed on a scan image. However, when an abnormal sheet occurs, since the number of print sheets is reduced due to the abnormal sheet, it is necessary to execute print again to replenish for the number of abnormal sheets. When the printing is executed again, since the printing condition is the same, the print distortion derived from the toner density of print is likely to recur. Therefore, in the third embodiment, the image inspection apparatus 109 presents to the user a strategy for preventing and reducing the occurrence of an abnormal sheet at the time of reprint. An example of presenting the user of the present embodiment a recurrence prevention measure and a recurrence reduction measure for an abnormal sheet will be described with reference to FIGS. 19 and 20.

FIG. 19 is an example of a UI screen presenting to the user a solution so that an abnormality at the time of reprint is less likely to occur. When the user operates the end button 1306, a warning window 1901 is displayed if an abnormality by distortion occurs in the inspection having ended. The warning window 1901 displays a message prompting a change in the sheet type, a change in the distortion threshold via the setting frame 1215, and the like. As described above, it is possible to prevent an abnormal sheet from occurring due to occurrence of the same distortion at the time of reprint. Although FIG. 19 presents a change in the sheet type as an example, the strategy for preventing recurrence, such as adjusting the picture as in FIG. 20 described later, is not limited to this.

FIG. 20 is an example of a UI screen presenting the user a strategy for making it difficult for an abnormality at the time of reprint to occur. When the user operates the end button 1306, a warning window 2001 is displayed if an abnormality by distortion occurs in the inspection having ended. The warning window 2001 displays a message prompting adjustment of the picture. In automatic adjustment of the picture, the distortion vector v3 and the print data stored in the image inspection apparatus 109 are received, and an inverse vector of the distortion vector v3 is applied to the print data, thereby performing automatic adjustment of the picture. Doing this cancels the distortion by the print data and print, and can obtain a print image free from distortion.

As described above, according to the third embodiment, it is possible to prevent an abnormal sheet from occurring due to occurrence of distortion at the time of reprint. Other than the strategy proposed here, for example, if it is possible to present a method of preventing recurrence such as making distortion less likely to occur by feeding back the acquired distortion vector v3 to the print apparatus 107, the method is not limited to that.

### Fourth Embodiment

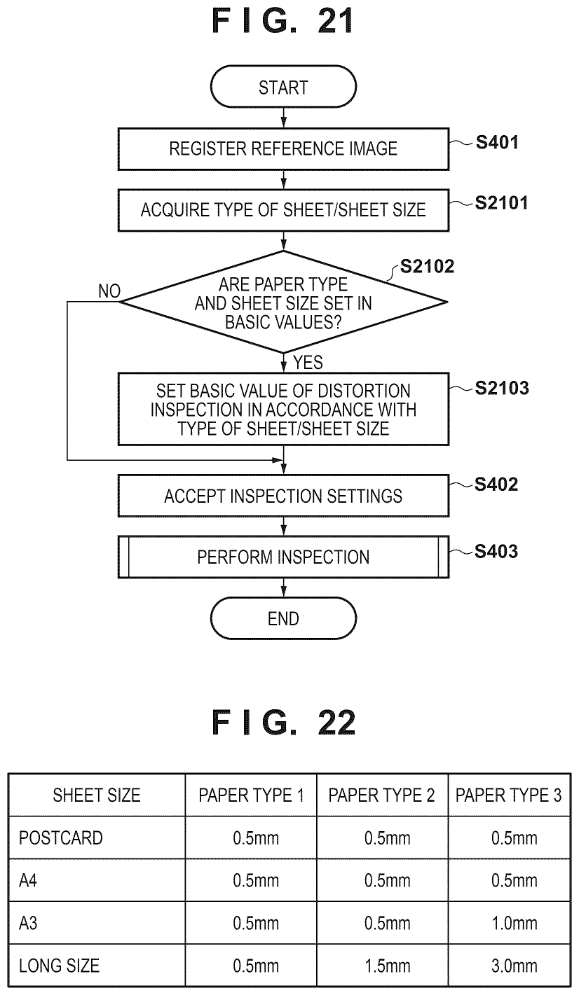

According to the first embodiment, it has been described as to whether to determine a sheet to be normal or an abnormality by the distortion amount on a scanned inspection image. However, it is necessary for the user himself to input the threshold of the distortion amount of distortion inspection, it is necessary to have knowledge of the influence on the easiness of occurrence of distortion by the paper type and the sheet size, and the burden on the user is large. Then, in the fourth embodiment, by inputting the paper type and the paper size, the user sets a threshold of the distortion amount as a preset. By automatically setting the threshold of the distortion amount, it is possible to reduce the burden on the user. A flow of presetting the threshold of the distortion amount depending on to the paper type will be described with reference to FIGS. 21 and 22. The processing described below is realized by, for example, the CPU 238 of the image inspection apparatus 109 reading a program stored in the HDD 255 into the memory 239 and executing the program.

As shown in FIG. 22, a basic value table in which a basic value of a threshold of a distortion amount is associated in accordance with the paper type and the sheet size is prepared in advance. In general, the larger the sheet size is, the larger the distortion amount is, and the thicker the sheet is, the smaller the misalignment amount and the distortion amount are.

In S2101, the CPU 238 prompts input from the operation unit 242 to acquire information on the paper type and the sheet size. The acquisition method is not limited to the input, and is not limited to this such as acquiring information on sheets set in the sheet feed decks 301 and 302 of the print apparatus 107, for example.

In S2102, the CPU 238 acquires the basic value table of FIG. 22, and determines whether the paper type and the sheet size acquired in S2101 exist in the basic value table. If the paper type and the sheet size are present in the basic value table (Yes), the basic value of the threshold of the distortion amount is acquired, and the process proceeds to S2103. If it is determined that the paper type and the sheet size acquired in S2102 are not present in the basic value table in S2102, the CPU 238 skips S2103 and the process proceeds to S402.

In S2103, the CPU 238 sets the basic value acquired from the basic value table as an initial value of the setting frame 1215 of the inspection setting UI in FIG. 12. The initial value set in FIG. 12 may remain as it is, or the user can change the setting when accepting the inspection setting in S402. Whether to perform or not to perform inspection of the distortion amount may be set in accordance with the type of sheet. In a case where the sheet size is small and the thickness of the sheet is large, the inspection of the distortion amount may be omitted. In this case, acquisition itself of the distortion amount is no longer necessary.

As described above, by estimating the distortion amount from the acquired sheet information and presetting it in the inspection setting, it is possible to reduce the burden of setting the threshold of the distortion amount by the user's own determination.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-103286, filed Jun. 26, 2024 which is hereby incorporated by reference herein in its entirety.

What is claimed is:

1. An image inspection apparatus comprising:
a scanning unit configured to scan a sheet on which an image is formed, the sheet being conveyed from an image forming unit;
one or more memory devices that store a set of instructions; and
one or more processors that execute the set of instructions to:
compare an overall image of the sheet scanned by the scanning unit with an overall reference image to detect a misalignment in a formation position in the image of the sheet, and align the image of the sheet with the reference image based on the misalignment to acquire a first image;
compare the first image with the reference image, detect distortion for each part of the image of the sheet, and locally align the first image with the reference image based on the distortion to acquire a second image; and
acquire a distortion amount from the distortion for each part to determine whether the image of the sheet is normal.

2. The image inspection apparatus according to claim 1, wherein
the one or more processors execute instructions in the one or more memory devices to:
further set thresholds as to whether to acquire the distortion amount and as to whether an image is normal based on the distortion amount.

3. The image inspection apparatus according to claim 1, further comprising a display unit, wherein the one or more processors execute instructions in the one or more memory devices to:
display, on a display unit, that the distortion is a cause when it is determined that the image of the sheet is not normal.

4. The image inspection apparatus according to claim 1, further comprising a display unit, wherein the one or more processors execute instructions in the one or more memory devices to:
display, on a display unit, that a strategy for reducing occurrence of the distortion when it is determined that the image of the sheet is not normal.

5. The image inspection apparatus according to claim 1, wherein
the scanning unit scans a calibration chart, and
the one or more processors execute instructions in the one or more memory devices to:
acquire distortion in the scanned calibration chart in advance, and remove distortion due to the scanning unit from the distortion for each part based on the acquired distortion in the calibration chart.

6. The image inspection apparatus according to claim 1, wherein the one or more processors execute instructions in the one or more memory devices to:
determine that the image of the sheet is not normal when the distortion amount exceeds a threshold.

7. The image inspection apparatus according to claim 2, wherein the one or more processors execute instructions in the one or more memory devices to: set, based on a type of sheet, thresholds as to whether to acquire the distortion amount and as to whether an image is normal based on the distortion amount.

8. The image inspection apparatus according to claim 1, wherein the one or more processors execute instructions in the one or more memory devices to:
further perform an abnormality inspection of an image for the image of the sheet determined to be normal.

9. An image inspection method comprising:
scanning a sheet on which an image is formed, the sheet being conveyed from an image forming unit;
comparing an overall image of the sheet scanned by the scanning unit with an overall reference image to detect a misalignment in a formation position in the image of the sheet, and aligning the image of the sheet with the reference image based on the misalignment to acquire a first image;
comparing the first image with the reference image, detecting distortion for each part of the image of the sheet, and locally aligning the first image with the reference image based on the distortion to acquire a second image; and
acquiring a distortion amount from the distortion for each part to determine whether the image of the sheet is normal.

10. A non-transitory computer-readable storage medium storing a program which, when executed by a computer of an inspection apparatus, causes the computer to perform an image inspection method, the inspection apparatus comprising a scanning unit configured to scan a sheet on which an image is formed, the sheet being conveyed from an image forming unit, the method comprising:
comparing an overall image of the sheet scanned by the scanning unit with an overall reference image to detect a misalignment in a formation position in the image of the sheet, and aligning the image of the sheet with the reference image based on the misalignment to acquire a first image,
comparing the first image with the reference image, detecting distortion for each part of the image of the sheet, and locally aligning the first image with the reference image based on the distortion to acquire a second image, and
acquiring a distortion amount from the distortion for each part to determine whether the image of the sheet is normal.

11. An image forming apparatus comprising:
an image forming unit configured to form an image on a sheet; and
the inspection apparatus according to claim 1.
